(19) United States
(12) Patent Application Publication
(10) Pub. No.: US 2023/0120832 A1
(43) Pub. Date: Apr. 20, 2023

(54) MONITORING DEVICE, COMMUNICATION SYSTEM, COMMUNICATION CONTROL METHOD, AND MONITORING PROGRAM

(71) Applicant: NIPPON TELEGRAPH AND TELEPHONE CORPORATION, Tokyo (JP)

(72) Inventors: Naotaka SHIBATA, Musashino-shi, Tokyo (JP); Hirotaka UJIKAWA, Musashino-shi, Tokyo (JP)

(73) Assignee: NIPPON TELEGRAPH AND TELEPHONE CORPORATION, Tokyo (JP)

(21) Appl. No.: 17/907,426

(22) PCT Filed: Mar. 30, 2020
(86) PCT No.: PCT/JP2020/014566

§ 371 Date: Sep. 27, 2022

(51) Int. Cl. H04W 24/08; H04W 76/10; H04W 28/02

(52) U.S. Cl. CPC H04W 24/08; H04W 28/0289; H04W 76/10

(57) ABSTRACT

A monitoring device that monitors a network to which a plurality of terminal devices establishing a connection based on TCP are connected, includes: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is larger than a preset value, transmits a command that sets the client to enlarge a congestion window to a predetermined value, regardless of presence or absence of an acknowledgement sent by the server.

### TECHNICAL FIELD

The present invention relates to a monitoring device, a communication system, a communication control method, and a monitoring program.

### BACKGROUND ART

In some communication systems where communication is performed over a network, highly reliable communication is accomplished between a client and a server by establishing a connection, for example, based on TCP (Transmission Control Protocol).

Terminal devices used in such communication systems include, for example, mobile telephones, smartphones, PCs (personal computers), server devices, and the like. For the network, a PON (Passive Optical Network), a mobile communication system, a ring network, a mesh network, and the like can be cited.

### CITATION LIST

### Non-Patent Literature

Non-Patent Literature 1: Takafumi Takeshita, et al. “Mastering TCP/IP - Elementary Edition”, Fifth edition, Ohmsha, Ltd., Feb. 25, 2012, pp. 230-256

### SUMMARY OF THE INVENTION

### Technical Problem

In TCP communication, an algorithm called slow start is adopted when communication is started, in order to prevent a network capacity from being exceeded as a result of a client such as a terminal device sending a large amount of data to a server from the beginning.

Slow start has parameters such as congestion window (CW), slow start threshold (SST), and the like.

An amount of data sent by a client depends on CW. Specifically, a client has an initial value of CW that is set low, receives an acknowledgment (ACK) from a destination (server), and exponentially increases the value of CW.

For this reason, conventionally, even if an available bandwidth of a network is large, time has been taken before throughput becomes high in some cases because a procedure of increasing the value of CW each time a client receives ACK is required.

An object of the present invention is to provide a monitoring device, a communication system, a communication control method, and a monitoring program that can shorten a time period spent before throughput of a terminal device increases when the terminal device performs communication by establishing a connection.

### Means for Solving the Problem

A monitoring device according to an aspect of the present invention is a monitoring device that monitors a network to which a plurality of terminal devices establishing a connection based on TCP are connected, the monitoring device including: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is larger than a preset value, transmits a command that sets the client to enlarge a congestion window to a predetermined value, regardless of presence or absence of an acknowledgement sent by the server.

A communication system according to an aspect of the present invention is a communication system including a plurality of terminal devices that establish a connection based on TCP, and a monitoring device that monitors communications of the plurality of terminal devices, the communication system including: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is larger than a preset value, transmits a command that sets the client to enlarge a congestion window to a predetermined value, regardless of presence or absence of an acknowledgement sent by the server.

A communication control method according to an aspect of the present invention is a communication control method for controlling communications of a plurality of terminal devices that establish a connection based on TCP, the communication control method including: a request detection step of detecting a connection establishment request that a terminal device becoming a client sends to another terminal device becoming a server; an available bandwidth calculation step of calculating an available bandwidth by subtracting a current amount of traffic from an allowable communication capacity, for each communication path identified by the detected connection establishment request; and a setting command step of, when the calculated available bandwidth is larger than a preset value, transmitting a command that sets the client to enlarge a congestion window to a predetermined value, regardless of presence or absence of an acknowledgement sent by the server.

### Effects of the Invention

According to the present invention, a time period spent before throughput of a terminal device increases can be shortened when the terminal device performs communication by establishing a connection.

### BRIEF DESCRIPTION OF DRAWINGS

FIG. 1 shows an example of a configuration of a communication system.

FIG. 2 is a graph showing changes over time in congestion window and slow start threshold in the communication system.

FIG. 3 shows an example of a configuration of a communication system according to an embodiment.

FIG. 4 is a functional block diagram showing an outline of functions included in a comprehensive monitoring device according to the embodiment.

FIG. 5 is a graph illustrating CW that a setting command unit sets on a client.

FIG. 6 shows an example of a configuration of a communication system according to an embodiment.

FIG. 7 is a functional block diagram showing an outline of functions included in a comprehensive monitoring device according to the embodiment.

FIG. 8 shows an example of a hardware configuration of the comprehensive monitoring device, according to an embodiment.

### DESCRIPTION OF EMBODIMENTS

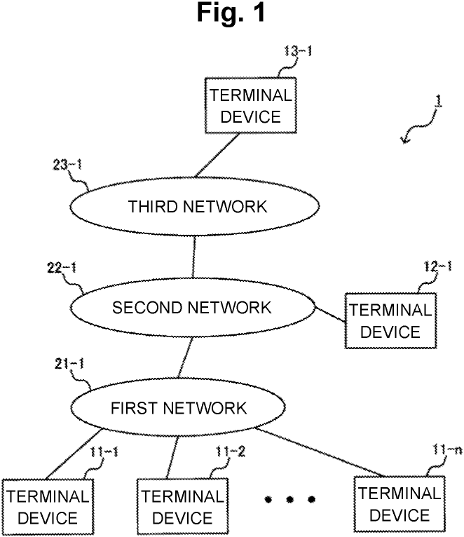

First, a description will be given of a background about how the present invention has been devised. FIG. 1 shows an example of a configuration of a communication system 1. As shown in FIG. 1, the communication system 1 includes, for example, a first network 21-1 to which terminal devices 11-1 to 11-n are connected, a second network 22-1 to which a terminal device 12-1 is connected, and a third network 23-1 to which a terminal device 13-1 is connected. In the communication system 1, the terminal devices 11-1 to 11-n, 12-1, and 13-1 can perform communication with each other by establishing a TCP connection.

Communication here may be any of wired communication and wireless communication. Note that when TCP communication is performed, it is assumed that any one of the terminal devices 11-1 to 11-n, 12-1, and 13-1 that first transmits a connection establishment request packet is a client, and that any one of the terminal devices 11-1 to 11-n, 12-1, and 13-1 that first receives the connection establishment request packet is a server.

As a more specific example of the configuration, the communication system 1 may be configured such that the terminal device 11-1 that is a mobile telephone performs TCP communication with the terminal device 13-1 that is a server (content server) installed in a data center and managing data (content).

In such a case, communication between the first network 21-1 and the terminal device 11-1 is, for example, wireless communication. The first network 21-1 is assumed to be a wireless network including a base station function and an antenna. The second network 22-1 is assumed to be, for example, a network in a predetermined area such as a prefecture, in a backhaul to the base station. The third network 23-1 is assumed to be a wide area network spanning prefectures or the like, in a backhaul to the base station. The third network 23-1 and the terminal device 13-1 perform communication, for example, through wired communication.

As another specific example of the configuration, the communication system 1 may be configured such that the terminal device 11-2 that is a PC performs TCP communication with the terminal device 12-1 that is also a PC.

Here, when the terminal device 11-2 performs P2P (Peer to Peer) communication with the terminal device 12-1, communication between the first network 21-1 and the terminal device 11-2 is, for example, wired communication. Moreover, the first network 21-1 is assumed to be a PON system in which FTTH (Fiber To The Home) is constructed. The second network 22-1 is also assumed to be a PON system in a different area from an area of the first network 21-1. The second network 22-1 and the terminal device 12-1 perform communication, for example, through wired communication.

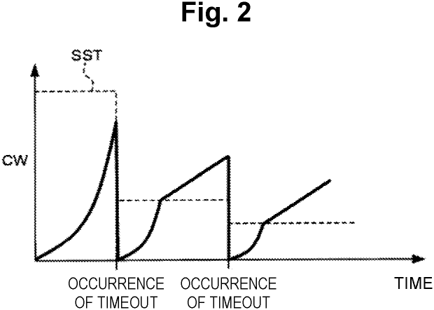

FIG. 2 is a graph showing changes over time in congestion window (CW) and slow start threshold (SST) in the communication system 1.

First, a client sets the size of CW to 1 MSS (Maximum Segment Size) when beginning slow start, and exponentially enlarges CW each time an acknowledgement (ACK) is received. A server notifies the client of a receivable window size according to a loaded state of the own device.

When sending a data packet, the client compares CW with the window size transmitted by the server, and sends the data packet in a size equal to or smaller than a lower one of the values of CW and the window size.

When a timeout occurs, the client resets CW to 1 and performs slow start again. Moreover, when the timeout occurs, the client sets the size of the slow start threshold to half the then window.

As described above, in TCP communication, throughput is gradually increased after communication is started, but when a network is congested, a timeout occurs and throughput suddenly decreases.

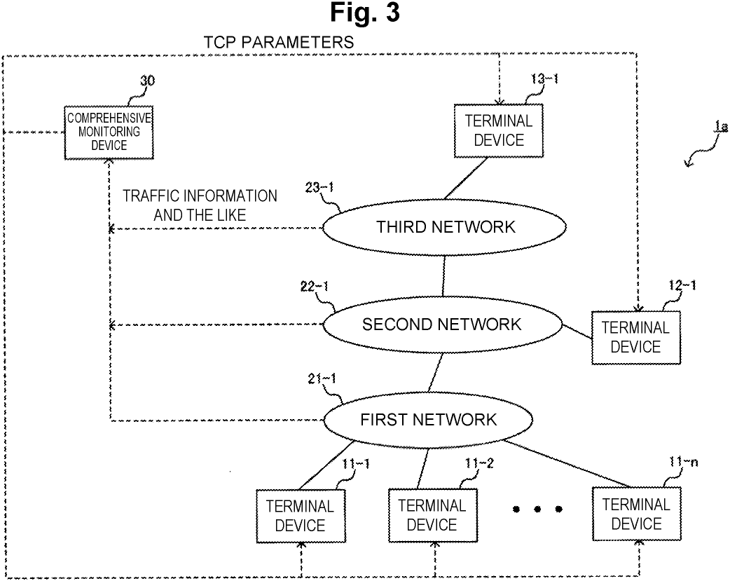

Next, a communication system according to an embodiment will be described. FIG. 3 shows an example of a configuration of a communication system 1a according to an embodiment.

As shown in FIG. 3, the communication system 1a includes, for example, a first network 21-1 to which terminal devices 11-1 to 11-n are connected, a second network 22-1 to which a terminal device 12-1 is connected, a third network 23-1 to which a terminal device 13-1 is connected, and a comprehensive monitoring device 30. In the communication system 1a, the terminal devices 11-1 to 11-n, 12-1, and 13-1 can perform communication with each other by establishing a TCP connection. Note that components that are substantially the same as the components of the communication system 1 shown in FIG. 1 are denoted by the same signs.

The comprehensive monitoring device 30 is a monitoring device that comprehensively monitors and controls network communications in the communication system 1a. For example, the comprehensive monitoring device 30 acquires traffic information on each path for communications performed by the terminal devices 11-1 to 11-n, 12-1, and 13-1, SYN packets for TCP connection establishment in the communication system 1a, and the like via the first network 21-1, the second network 22-1, and the third network 23-1, and transmits control parameters (TCP parameters) for TCP communication to the terminal devices 11-1 to 11-n, 12-1, and 13-1.

Note that a path (communication path) through which the comprehensive monitoring device 30 transmits the TCP parameters may be any path. For example, the comprehensive monitoring device 30 transmits the TCP parameters to the terminal devices 11-1 to 11-n, 12-1, and 13-1 via the first network 21-1, the second network 22-1, and the third network 23-1.

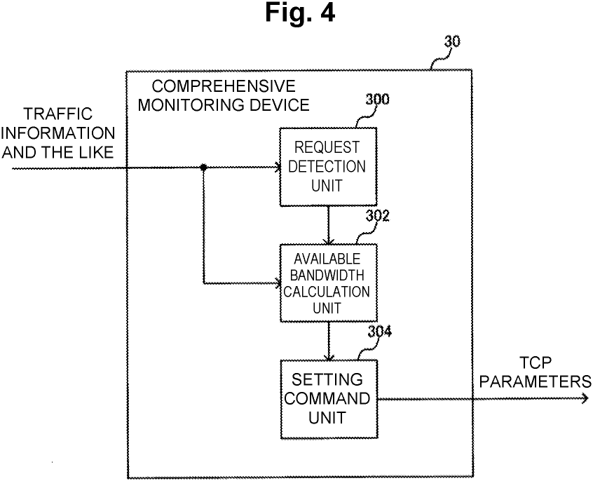

FIG. 4 is a functional block diagram showing an outline of functions included in the comprehensive monitoring device 30 according to the embodiment. The comprehensive monitoring device 30 includes, for example, a request detection unit 300, an available bandwidth calculation unit 302, and a setting command unit 304.

The request detection unit 300 detects a TCP connection establishment request (SYN packet: connection request) that a terminal device becoming a client sends to another terminal device becoming a server, and outputs information indicating that the client has sent the connection establishment request to the server, a source address, and a destination address to the available bandwidth calculation unit 302.

For each communication path identified by the connection establishment request detected by the request detection unit 300, the available bandwidth calculation unit 302 calculates an available bandwidth by subtracting a current amount of traffic from an allowable communication capacity.

For example, the available bandwidth calculation unit 302 stores a communication capacity of each network (each communication path) beforehand, measures a currently used bandwidth by using a network traffic amount measurement function included in the available bandwidth calculation unit 302, and calculates an available bandwidth by subtracting the amount of traffic from the communication capacity.

At the time, the available bandwidth calculation unit 302 narrows all networks in the communication system 1a down to networks to be followed by a communication for which the SYN packet is detected by the request detection unit 300, and calculates an available bandwidth by using traffic information indicating an amount of traffic and the like on each of the networks. The available bandwidth calculation unit 302 outputs, for example, the smallest value of the available bandwidths of the individual networks to the setting command unit 304.

Note that the available bandwidth calculation unit 302 may use an IP address or a MAC address in narrowing down to the networks to be followed by the communication for which the SYN packet is detected. In other words, the available bandwidth calculation unit 302 may store an IP address or a MAC address on a network through which data has passed, and may identify under which network the stored IP address or MAC address exists. When networks (communication paths) cannot be narrowed down, the available bandwidth calculation unit 302 may calculate the available bandwidth on the assumption that data follows all communication paths.

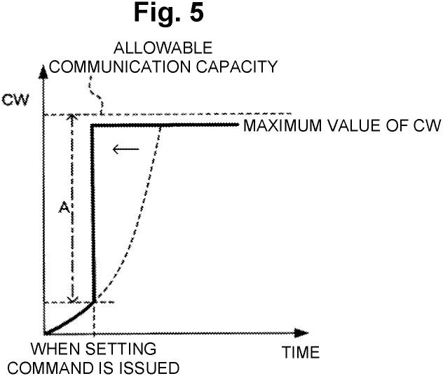

When the available bandwidth calculated by the available bandwidth calculation unit 302 is larger than a preset value, the setting command unit 304 transmits a command that sets the client to enlarge the congestion window (CW) to a predetermined value, regardless of presence or absence of an acknowledgement (ACK) sent by the server. A specific description will be given by using FIG. 5.

FIG. 5 is a graph illustrating the congestion window (CW) that the setting command unit 304 sets on a client. As shown in FIG. 5, in the beginning, the comprehensive monitoring device 30 causes CW to be exponentially increased, according to an acknowledgement (ACK) sent by the server.

When the available bandwidth (for example, A —allowable communication capacity — amount of traffic, shown in FIG. 5) calculated by the available bandwidth calculation unit 302 is larger than a predetermined threshold B (not shown), the setting command unit 304 transmits a command that sets the client to enlarge CW, for example, to a maximum value, without waiting for an acknowledgement (ACK) sent by the server.

Moreover, the setting command unit 304 may transmit a command that sets the client to increase the value of CW to respective values that differ according to a plurality of predetermined thresholds.

As a specific example, the setting command unit 304 may transmit a command that sets the client to enlarge CW to a value that varies each time the available bandwidth calculated by the available bandwidth calculation unit 302 becomes equal to or larger than each one of the plurality of predetermined thresholds (first to n-th thresholds).

In the comprehensive monitoring device 30, when the request detection unit 300 detects a plurality of communications (SYN packets) at the same time, the setting command unit 304 may transmit commands that set the clients, based on a total amount of traffic of the plurality of communications, and an available bandwidth of each communication path.

Further, when the plurality of communications include communications with different degrees of priority or different degrees of importance of services or the like, the setting command unit 304 may be configured to transmit a command that makes a setting to enlarge CW in descending order from a communication with the highest degree of priority or the highest degree of importance.

For example, the comprehensive monitoring device 30 may perform processing of increasing the amount of traffic by enlarging CW in descending order from a communication with the highest degree of priority or the highest degree of importance, and when the available bandwidth becomes small thereafter, stopping increasing the value of CW for communications with higher degrees of priority or higher degrees of importance.

Then, the client compares a bandwidth based on the own CW and SST with a bandwidth indicated by the window size, and sends an amount of data adapted to the smaller bandwidth to the server.

Note that the client is assumed to include a function of changing the value of CW, according to the TCP parameter (setting command) transmitted from the comprehensive monitoring device 30.

As described above, the communication system 1a can avoid congestion by increasing throughput of traffic with a higher degree of priority or a higher degree of importance, while restraining throughput of traffic with a lower degree of priority or a lower degree of importance.

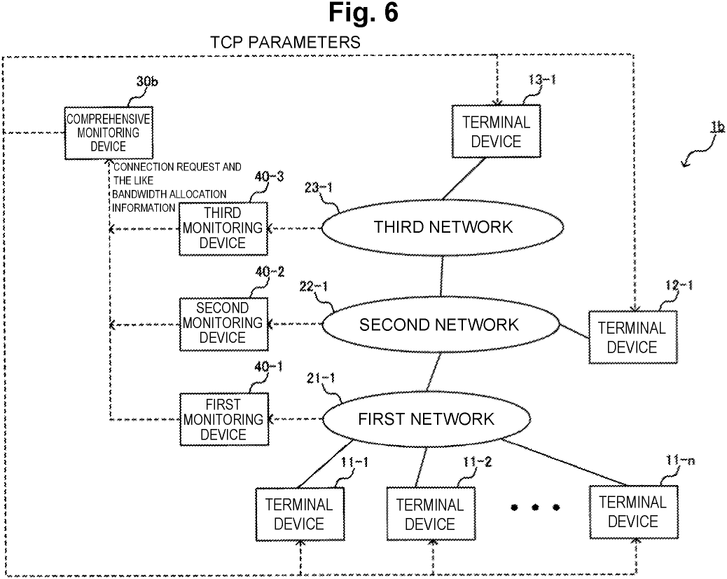

Next, a first modification example (communication system 1b) of the communication system 1a, according to an embodiment will be described. FIG. 6 shows an example of a configuration of the communication system 1b according to the embodiment.

As shown in FIG. 6, the communication system 1b includes, for example, a first network 21-1 to which terminal devices 11-1 to 11-n are connected, a second network 22-1 to which a terminal device 12-1 is connected, a third network 23-1 to which a terminal device 13-1 is connected, a comprehensive monitoring device 30b, and a first monitoring device 40-1 to a third monitoring device 40-3. In the communication system 1b, the terminal devices 11-1 to 11-n, 12-1, and 13-1 can perform communication with each other by establishing a TCP connection. Note that components that are substantially the same as the components of the communication system 1 shown in FIG. 1 are denoted by the same signs.

The first monitoring device 40-1 is a monitoring device that monitors and controls network communications in the first network 21-1. For example, the first monitoring device 40-1 acquires traffic information on each path for communications performed by the terminal devices 11-1 to 11-n over the first network 21-1, SYN packets (connection requests) for TCP connection establishment, and the like, and outputs the acquired connection requests and respective bandwidth allocation information on the communications in the first network 21-1, to the comprehensive monitoring device 30b.

Specifically, the first monitoring device 40-1 detects a connection request in the first network 21-1, and transmits information indicating that a client has sent a connection establishment request to a server, a source address, a destination address, and bandwidth allocation information to the comprehensive monitoring device 30b.

The second monitoring device 40-2 is a monitoring device that monitors and controls network communications in the second network 22-1. For example, the second monitoring device 40-2 acquires traffic information on each path for a communication performed by the terminal device 12-1 over the second network 22-1, a SYN packet (connection request) for TCP connection establishment, and the like, and outputs the acquired connection request and respective bandwidth allocation information on the communication in the second network 22-1, to the comprehensive monitoring device 30b.

Specifically, the second monitoring device 40-2 detects a connection request in the second network 22-1, and transmits information indicating that a client has sent a connection establishment request to a server, a source address, a destination address, and bandwidth allocation information to the comprehensive monitoring device 30b.

The third monitoring device 40-3 is a monitoring device that monitors and controls network communications in the third network 23-1. For example, the third monitoring device 40-3 acquires traffic information on each path for a communication performed by the terminal device 13-1 over the third network 23-1, a SYN packet (connection request) for TCP connection establishment, and the like, and outputs the acquired connection request and respective bandwidth allocation information on the communication in the third network 23-1, to the comprehensive monitoring device 30b.

Specifically, the third monitoring device 40-3 detects a connection request in the third network 23-1, and transmits information indicating that a client has sent a connection establishment request to a server, a source address, a destination address, and bandwidth allocation information to the comprehensive monitoring device 30b.

The comprehensive monitoring device 30b is a monitoring device that comprehensively monitors and controls network communications in the communication system 1b. For example, the comprehensive monitoring device 30b acquires the traffic information on each path for the communications performed by the terminal devices 11-1 to 11-n, 12-1, and 13-1, the SYN packets (connection requests) for TCP connection establishment in the communication system 1b, the respective bandwidth allocation information, and the like via the first monitoring device 40-1 to third monitoring device 40-3, and transmits the control parameters (TCP parameters) for TCP communication to the terminal devices 11-1 to 11-n, 12-1, and 13-1.

Note that a path (communication path) through which the comprehensive monitoring device 30b transmits the TCP parameters may be any path. For example, the comprehensive monitoring device 30b may transmit the TCP parameters to the terminal devices 11-1 to 11-n, 12-1, and 13-1 via the first monitoring device 40-1 to third monitoring device 40-3.

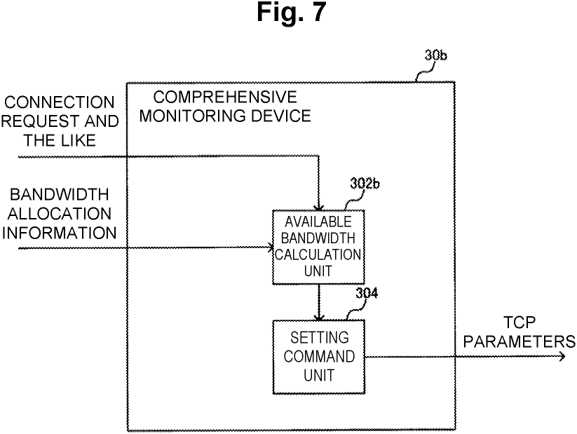

FIG. 7 is a functional block diagram showing an outline of functions included in the comprehensive monitoring device 30b according to the embodiment. The comprehensive monitoring device 30b includes, for example, an available bandwidth calculation unit 302b and a setting command unit 304.

The available bandwidth calculation unit 302b calculates an available bandwidth based on the bandwidth allocation information inputted from the first monitoring device 40-1 to third monitoring device 40-3, for each communication path identified by the connection requests inputted from the first monitoring device 40-1 to third monitoring device 40-3, and outputs the available bandwidth to the setting command unit 304. For example, the available bandwidth calculation unit 302b calculates an available bandwidth by subtracting an amount of traffic based on the current bandwidth allocation information from a communication capacity allowable for each communication path.

When a connection request is detected in a plurality of networks, the available bandwidth calculation unit 302b, for example, collects communication paths with coinciding source addresses and destination addresses, and, for each set of the collected communication paths, outputs the smallest value of the available bandwidths to the setting command unit 304.

When the available bandwidth calculated by the available bandwidth calculation unit 302 is larger than a predetermined threshold, the setting command unit 304 transmits a command that sets the client to enlarge CW, for example, to a maximum value, without waiting for an acknowledgement (ACK) sent by the server.

In other words, a processing load on the comprehensive monitoring device 30b is lighter than a processing load on the above-described comprehensive monitoring device 30.

As described hereinabove, when an available bandwidth is larger than a preset value, the communication system 1a, 1b transmits a command that sets the client to enlarge the congestion window to a predetermined value, regardless of presence or absence of an acknowledgement sent by the server. Accordingly, when a terminal device performs communication by establishing a connection, a time period spent before throughput of the terminal device increases can be shortened.

Note that one or some, or all, of the functions included in the terminal devices 11-1 to 11-n, 12-1, and 13-1, the comprehensive monitoring devices 30 and 30b, and the first monitoring device 40-1 to third monitoring device 40-3 may be configured by using hardware, or may be configured as a program to be executed by a processor such as a CPU.

In other words, the communication system 1 according to the present invention can be implemented by using a computer and a program, and the program can be recorded on a storage medium or can be provided through a network.

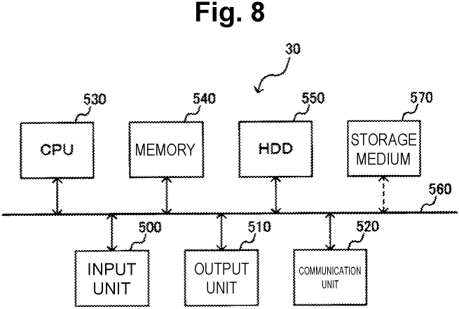

FIG. 8 shows an example of a hardware configuration of the comprehensive monitoring device 30, according to an embodiment. As shown in FIG. 8, in the comprehensive monitoring device 30, for example, an input unit 500, an output unit 510, a communication unit 520, a CPU 530, a memory 540, and an HDD 550 are connected through a bus 560, and the comprehensive monitoring device 30 has functions as a computer. The comprehensive monitoring device 30 is configured to be able to receive data as input from and output data to a storage medium 570.

The input unit 500 includes, for example, a keyboard, a mouse, and the like. The output unit 510 is, for example, a display device such as a display. The communication unit 520 is, for example, a wireless or wired network interface.

The CPU 530 controls each unit included in the comprehensive monitoring device 30 and performs the above-described processing. The memory 540 and the HDD 550 store data. The storage medium 570 is configured to be able to store a monitoring program that causes the functions included in the comprehensive monitoring device 30 to be executed, and the like. An architecture that configures the comprehensive monitoring device 30 is not limited to the example shown in FIG. 8. The comprehensive monitoring device 30b may include components similar to the components of the comprehensive monitoring device 30.

### Reference Signs List

1, 1a, 1b Communication system
11-1 to 11-n, 12-1, 13-1 Terminal device
21-1 First network
22-1 Second network
23-1 Third network
30, 30b Comprehensive monitoring device
40-1 First monitoring device
40-2 Second monitoring device
40-3 Third monitoring device
300 Request detection unit
302, 302b Available bandwidth calculation unit
304 Setting command unit
500 Input unit
510 Output unit
520 Communication unit
530 CPU
540 Memory
550 HDD
560 Bus
570 Storage medium

1. A monitoring device that monitors a network to which a plurality of terminal devices establishing a connection based on TCP are connected, the monitoring device comprising:
a processor; and
a storage medium having computer program instructions stored thereon, when executed by the processor, perform to:
detects a connection establishment request that a terminal device becoming a client sends to another terminal device becoming a server;
calculates an available bandwidth by subtracting a current amount of traffic from an allowable communication capacity, for each communication path identified by the connection establishment request ; and
when the available bandwidth is larger than a preset value, transmits a command that sets the client to enlarge a congestion window to a predetermined value, regardless of presence or absence of an acknowledgement sent by the server.

2. The monitoring device according to claim 1, wherein the computer program instructions further perform to transmits a command that sets the client to enlarge the congestion window to a maximum value, or a command that sets the client to increase a value of the congestion window to respective values that differ according to a plurality of predetermined thresholds.

3. The monitoring device according to claim 1, wherein the computer program instructions further perform to transmits a command that makes a setting to increase a value of the congestion window in descending order from a communication with a highest degree of priority or a highest degree of importance.

4. A communication system including a plurality of terminal devices that establish a connection based on TCP, and a monitoring device that monitors communications of the plurality of terminal devices, the communication system comprising:
a request detection unit that detects a connection establishment request that a terminal device becoming a client sends to another terminal device becoming a server;
an available bandwidth calculation unit that calculates an available bandwidth by subtracting a current amount of traffic from an allowable communication capacity, for each communication path identified by the connection establishment request detected by the request detection unit; and
a setting command unit that, when the available bandwidth calculated by the available bandwidth calculation unit is larger than a preset value, transmits a command that sets the client to enlarge a congestion window to a predetermined value, regardless of presence or absence of an acknowledgement sent by the server.

5. The communication system according to claim 4, wherein the setting command unit transmits a command that sets the client to enlarge the congestion window to a maximum value, or a command that sets the client to increase a value of the congestion window to respective values that differ according to a plurality of predetermined thresholds.

6. The communication system according to claim 4 , wherein the setting command unit transmits a command that makes a setting to increase a value of the congestion window in descending order from a communication with a highest degree of priority or a highest degree of importance.

7. A communication control method for controlling communications of a plurality of terminal devices that establish a connection based on TCP, the communication control method comprising:
a request detection step of detecting a connection establishment request that a terminal device becoming a client sends to another terminal device becoming a server;
an available bandwidth calculation step of calculating an available bandwidth by subtracting a current amount of traffic from an allowable communication capacity, for each communication path identified by the detected connection establishment request; and
a setting command step of, when the calculated available bandwidth is larger than a preset value, transmitting a command that sets the client to enlarge a congestion window to a predetermined value, regardless of presence or absence of an acknowledgement sent by the server.

8. A monitoring program for causing a computer to function the monitoring device according to claim 1 .
